(19) United States
(12) Patent Application Publication
(10) Pub. No.: US 2017/0169180 A1
(43) Pub. Date: Jun. 15, 2017

(54) SITUATION-DEPENDENT BLENDING METHOD FOR PREDICTING THE PROGRESSION OF DISEASES OR THEIR RESPONSES TO TREATMENTS

(71) Applicant: International Business Machines Corporation, Armonk, NY (US)

(72) Inventors: HENDRIK F. HAMANN, YORKTOWN HEIGHTS, NY (US); SIYUAN LU, YORKTOWN HEIGHTS, NY (US)

(21) Appl. No.: 14/967,551

(22) Filed: Dec. 14, 2015

(51) Int. Cl. G06F 19/00

(52) U.S. Cl. CPC G06F 19/3437

(57) ABSTRACT

A method of predicting progression of a disease in a patient includes selecting a physiological parameter of interest and a range of inputs for a set of individual predictive disease models; running, using a processor, the set of individual predictive disease models with the range of inputs to obtain an estimate from model; identifying experimental observations; identifying critical parameters among the estimates of the physiological parameters of interest, the critical parameters exhibiting a specified correlation with an error in estimation of the physiological parameters of interest; obtaining, for each subspace of all possible combinations of critical parameters, a model based on blending the estimates so that the blended prediction best fits the experimental observations; and determining a prediction to predict disease progression or response to a treatment for the patient using the blended model.

### BACKGROUND

The present invention relates to model blending, and more specifically, to situation-dependent blending for predicting progression of diseases or their responses to treatments.

Predictive models for the progression of certain diseases and their response to treatments are playing an increasingly important role in medicine. Such models can be either short-term or long-term.

Examples of short-term models include glucose modeling for diabetic patients that predict the time-dependent evolution of a patient's blood sugar level with or without insulin administration. These models are used to manage diabetes and to develop an artificial pancreas to control blood sugar using a closed loop. Some laboratories have independently developed mathematical models for such purposes, including for example, the Aida model, the Diabetes Advisory System (DIAS) model, the Glucosim model, and the like.

Examples of long-term models include modeling the progression of a cancer and its response to chemotherapy or radiotherapy. Such models play a role in personalized medication for individual patients. Other models have been developed for predicting cancer progression and response to treatment.

Disease models may be in various forms. For example, the model may be based on ordinary or partial differential equations, integro-differential equations, or heuristics.

### SUMMARY

According to an embodiment, a method of predicting progression of a disease in a patient includes selecting a physiological parameter of interest and a range of inputs for a set of individual predictive disease models; running, using a processor, the set of individual predictive disease models with the range of inputs to obtain an estimate of the physiological parameters of interest from each individual predictive disease model; identifying experimental observations for the physiological parameters of interest; identifying critical parameters among the estimates of the physiological parameters of interest, the critical parameters exhibiting a specified correlation with an error in estimation of the physiological parameters of interest; obtaining, for each subspace of all possible combinations of critical parameters, a blended model based on blending the estimates of the physiological parameters of interest from the set of individual predictive disease models so that the blended prediction best fits the experimental observations; and determining a prediction of the physiological parameter of interest to predict disease progression or response to a treatment for the patient using the blended model.

According to another embodiment, a system to predict progression of a disease in a patient includes an input interface configured to receive inputs, the inputs including a physiological parameter of interest and a range of inputs for a set of individual predictive disease models; and a processor configured to: run the set of individual models with the range of inputs to obtain an estimate of the physiological parameters from each individual predictive disease model, identify experimental observations for the physiological parameters of interest, identify critical parameters among the estimates of the physiological parameters of interest, the critical parameters exhibiting a specified correlation with an error in estimation of the physiological parameters of interest, obtain, for each subspace of all possible combinations of critical parameters, a blended model based on blending the estimates of the physiological parameters of interest from the set of individual predictive disease models so that the blended prediction best fits the experimental observations, and determine a prediction of the physiological parameter of interest to predict disease progression or response for the patient using the blended model.

Yet, according to another embodiment, a non-transitory computer program product having computer readable instructions stored thereon which, when executed by a processor, cause the processor to implement a method of predicting progression of a disease in a patient, the method including selecting a physiological parameter of interest and a range of inputs for a set of individual predictive disease models; running, using a processor, the set of individual predictive disease models with the range of inputs to obtain an estimate of the physiological parameters of interest from each individual predictive disease model; identifying experimental observations for the physiological parameters of interest; identifying critical parameters among the estimates of the physiological parameters of interest, the critical parameters exhibiting a specified correlation with an error in estimation of the physiological parameters of interest; obtaining, for each combination of critical parameters, a blended model based on blending the estimates of the physiological parameters of interest from the set of individual predictive disease models and the experimental observations; and determining a prediction of the physiological parameter of interest to predict disease progression or response for the patient using the blended model.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a process flow of a method of predicting progression of a disease in a patient according to embodiments;

FIG. 2 is a process flow of a method of predicting progression of diabetes or response to a diabetes treatment in a patient according to an embodiment;

FIG. 3 is a process flow of a method of training a blended disease model for a subspace of all possible combinations of the critical parameters according to an embodiment;

FIG. 4 is a process flow of a method of classifying patients in a pool and obtaining proxy patients according to an embodiment; and

FIG. 5 is a block diagram of a multi-model blending system for predicting progression of a disease in a patient according to an embodiment.

### DETAILED DESCRIPTION

As noted above, a model may be used to predict the progression of diseases and their response to treatments. However, an individual model may not reliably predict a disease for all patients and under all circumstances. An intelligent combination of the individual disease model thus may provide a higher prediction accuracy.

Further, application of individual models may need additional correction when applied towards an individual patient. Because data for individual patients may be limited, a majority of the experimental data for diseases may be derived from animal models or an “average” patient population.

Accordingly, disclosed herein are methods and systems to improve the prediction accuracy for diseases, including the progression of the diseases or their responses to treatments. The methods and systems are based on a super-model that is constructed by machine-learning based situation dependent blending of multiple individual input disease models. The super-model is more accurate than the input models, each of which individually may have its own weaknesses and strengths. The super disease model is adapted from a group of patient and applied such that it fits the individual patient.

Although a super-model approach has been applied to prediction of the future state of physical systems, such as in forecasting weather and in prediction of oil/gas pipeline corrosion rates, the methodology has not been applied to prediction of human diseases. The forward modeling of the human body or other biological systems is generally empirical because such systems are complex with many unknown details. In contrast, models of physical systems, such as weather, are generally established based on first principle laws of physical and chemistry. The extension of super-model approaches from physical system to disease prediction is based on the realization that the disease models nevertheless manifest significant situation-dependent error that is similar to the physical models. For example, in certain sub-regions of the parameter space, models may have similar positive or negative prediction errors. Such situation dependent error remains valid in spite of disease modeling belonging to a different discipline and involving substantially different domain knowledge compared to most physical systems.

Moreover, the initial and environmental conditions of biological systems usually are not fully known and/or controlled. Thus, even when individuals are exposed to the same environments, the response of the individual biological systems will have a distribution, and in many cases, there are behavioral outliers. Therefore, when extending the super-model approach from a physical system to a biological system, properties of the biological systems should be considered to ensure that (1) when collecting historical data, outlier behaviors are eliminated, and (2) predictions are provided as a distribution of the responses of biological system, not only as the average response.

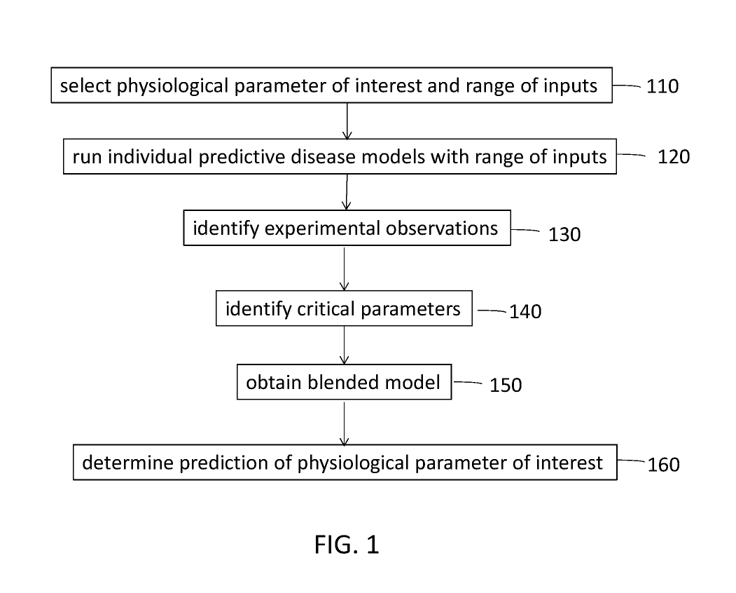

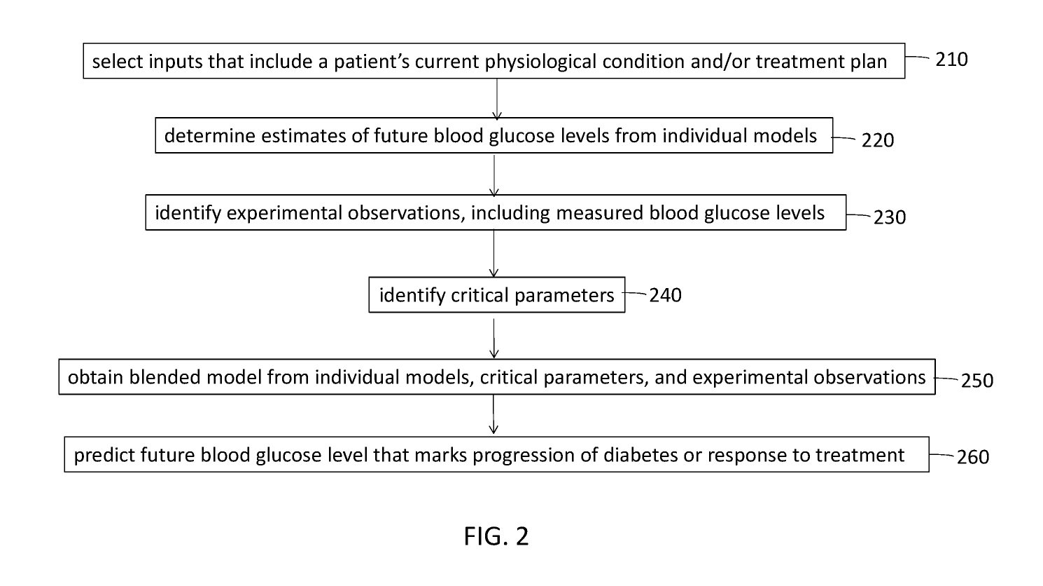

FIG. 1 is a process flow of a method of predicting progression of a disease in a patient according to embodiments. As used herein, the term “progression of a disease” means natural progression of the disease or progression in response to a treatment plan. At block 110, a physiological parameter of interest and a range of inputs for a set of individual predictive disease models are selected. For purposes of explanation, a specific example of the estimate of interest is blood glucose when the disease is diabetes is described in FIG. 2 below. The exemplary models discussed herein that estimate or predict blood glucose levels and predict responses to various treatment plans have different inputs based on the individual model. As noted above, the discussion herein applies to any number of types of models and any estimates of a physiological parameter of interest associated with those models.

The physiological parameter of interest depends on the patient and may be derived from any disease or condition. The disease or condition may be, but is not limited to, diabetes, thyroid disease, or hypertension.

The range of inputs may include the patient's current physiological conditions, such as current blood glucose level, age, gender, weight, and treatment plans. The treatment plan may be that not treatment plan has been implemented for the patient. Other exemplary treatment plans include chemotherapy when the disease is cancer or an oral beta blocker when the condition is hypertension.

At block 120, the set of individual predictive disease models are run with different input values, which results in a range of predictions or estimates of the physiological parameters derived from each individual predictive disease model. While only estimates may be used herein, the models (individual and blended) may provide predictions of future parameter values, as well as estimates of parameter values corresponding with a time at which input values were obtained. The range of estimates of parameters includes the estimate of the physiological parameter of interest (a range of estimates of the physiological parameter of interest).

At block 130, experimental observations are identified. The experimental observations may be derived from, for example, a clinical trial for a large pool of patients or from animal model experiments. The experimental observations may be, but are not limited to, actual observations from the patient, such as measured blood pressure or cancer marker levels.

As detailed further below, identifying critical parameters, at block 140, includes identifying, among the parameters estimated by the individual models, those parameters that have the greatest influence on the error in the estimate of the parameter of interest. The physiological parameter of interest itself may be one of the critical parameters. The critical parameters may be for example, years after acquiring a disease or condition, heart rate, blood pressure, etc.

Once the critical parameters are identified, setting a subspace of the critical parameters is done iteratively. Setting the subspace of critical parameters includes considering a combination of a sub-range of each critical parameter per iteration. The sub-range of values considered for a given critical parameter need not be continuous. As further discussed below, dependence of the error in the estimation of the physiological parameter of interest may be similar for different sets of values of a critical parameter.

The critical parameters may be identified using various methods. In one example, functional analysis-of-variance (FANOVA) in the first order may be used to examine the first order dependence of the error in the estimating the physiological parameter of interest associated with each of the potential critical parameters. FANOVA is a technique of using statistical models to analyze variance and explain observations. Its application may be used to build a statistical model of prediction error (in predicting the physiological parameter of interest by a given individual model) as a function of all input parameters. Error in estimate may be computed as:

E=F(x₁,x₂, . . . ,xₙ) [EQ. 1]

EQ. 1 provides the model forecast error (E) of the physiological parameter of interest. x₁, x₂, . . . ,xₙ are the other n physiological parameters that are also predicted or estimated by the individual model. The statistical models may be too noisy to be used directly and are therefore decomposed to 0^{th}, 1^{st}, 2^{nd}, and higher order dependence of predicted or estimated error as follows:

$$F = {f}_{0} + {\sum }_{i} {f}_{i} ( {x}_{i} ) + {\sum }_{i \neq j} {f}_{i , j} ( {x}_{i} , {x}_{j} ) + … \qquad [ EQ . 2 ]$$

The first order dependence f₁ (of error in estimating the physiological parameter of interest) on a single variable (another parameter estimated by the same individual model) is then given by:

fᵢ=∫F(x₁, . . . ,xₙ)dx₁ . . . dxᵢ₋₁dᵢ₊₁dxₙ−f₀ [EQ. 3]

The first order dependence on different parameter values are used to examine the dependence of error on the individual parameters. The error in the estimate of parameters is first order error when it depends on only one parameter. The effects of the other parameters on the estimation error are averaged out in EQ. 3.

Each parameter is correlated with the first order error in estimating the parameter of interest. The standard deviation of the first order error for the estimates corresponding with a given parameter is determined. In particular, the mean value of first order estimate error is determined, and the deviation from each data point from the mean value is used to compute standard deviation. Thus, the standard deviation is a measure of the spread in estimation error dependence corresponding to each parameter and is given by:

$$standard\_deviation = \sqrt{\frac{{\sum }_{i = 1}^{N} {( {X}_{i} - mean )}^{2}}{N - 1}} \qquad [ EQ . 4 ]$$

In EQ. 4, N is the total number of first order error dependence values associated with a given parameter, and Xᵢ refers to each first order error dependence value. These methods identify the important parameters in terms of first order error in estimation of physiological parameters of interest. This identification of influential parameters may be based on setting a threshold for the standard deviations of the error dependence on different parameters, for example.

In addition to using first order error dependence to identify critical parameters, second order error dependence on parameters may be used. The mean value of second order estimate error is determined, and then the standard deviation is determined based on the deviation from that mean value at each point. While the standard deviation of the first order estimation error dependence is based on one parameter, as discussed above, the standard deviation of the second order estimation error dependence is based on a combination of two parameters. A threshold value may be used to select the combinations as influential combinations of parameters with respect to estimation error for the physiological parameter of interest. The FANOVA second order dependence (derived from EQ. 2) is given by:

f_{i,j}=∫F(x₁, . . . ,xₙ)dx₁ . . . dxᵢ₋₁dxᵢ₊₁ . . . dxⱼ₋₁dxⱼ₊₁ . . . dxₙ−fᵢ(xᵢ)−fⱼ(xⱼ)−f₀ [EQ. 5]

The first and second order estimation error associated with one individual model, and the process of examining the parameters is repeated for other individual models. The process of examining the parameters may also be extend to higher order (third order or above) error dependences. In addition, cross-model parameter dependence may also be considered.

After the first and/or second order estimation error is determined for each model, inter-model second order error dependence is examined. Overlap predictions of two or more models may be used to determine how the error of the prediction of the parameter of interest by a model is statistically correlated to the prediction of a first parameter by a first model and the prediction of a second parameter by a second model.

Based on the first and second order errors and on inter-model error correlation described in the discussion above, critical parameters are identified. These critical parameters are determined to have the highest (e.g., above a threshold) correlation with the error in estimating the physiological parameter of interest. The same parameters may not be critical parameters in each individual model. However, the processes discussed above identify parameters that are deemed critical in at least one individual model. If the number of these critical parameters is only one or two, then blending the individual models may be achieved in a straight-forward manner by a weighted linear combination, for example.

Obtaining the blended model, at block 150, may involve obtaining a training data set that falls in a number of subspaces. Each subspace is defined by a specific set of the critical parameters, and each critical parameter in the set is within a specific subrange of possible values. The subrange of a parameter does not have to be continuous. An exemplary embodiment for dividing the historical data into subspaces is to use the prediction error of the parameter of interest as the criteria. Namely, within in a given subspace, the prediction error of the parameter of interest has similar values. For historical data in each subspace of the critical parameters, a machine learning algorithm is used to train a blended model. The blended model is based on blending the estimates of the physiological parameters of interest from the set of individual predictive disease models so that the blended result best fits the experimental observations.

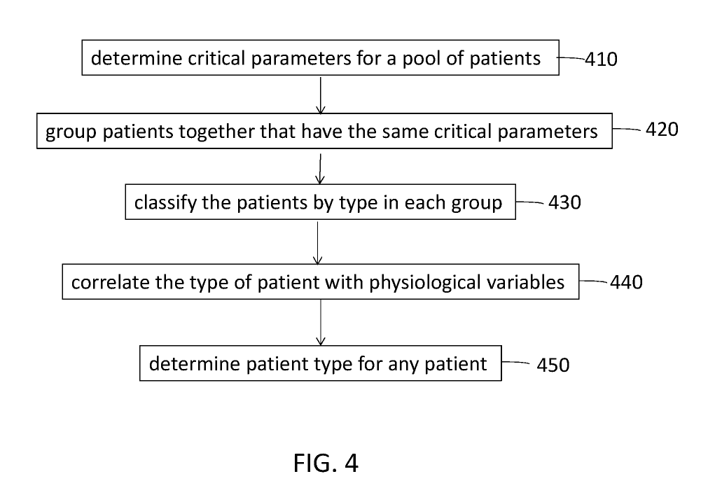

The machine learning algorithm may be trained using the predictions, critical parameters, and experimental observations. The machine learning algorithm may include multi-expert based machine learning and is described in further detail in FIG. 4 below. Briefly, the training data sets consider available data (e.g., from a pool of patients) which fall in a number of subspaces. Each subspace is a particular combination of the critical parameters, and each critical parameter is set at a particular sub-range of its values. A sub-range is not necessarily a continuous range of values.

An exemplary embodiment for dividing the total available data into subspaces involves using the estimation error of the physiological parameter of interest. That is, within a subspace, the estimation error of the physiological parameter of interest is similar. Once trained, the resulting blended model may be applied for estimation where the critical parameters fall in the same subspace.

According to embodiments detailed below, the machine learning may be accomplished by a multi-expert based machine learning system. Additionally, according to embodiments detailed below, the issue of obtaining training datasets is addressed. That is, when training data is not available for the particular patient, proxy patients that provide comparable and sufficient training data to be used in generating a blended model that may then be applied to the particular patient are needed (see FIG. 4).

At block 160, the blended model is used to predict the physiological parameter of interest to predict disease progression or response for the patient. Once trained, the blended model can be used for future predictions when no observation is available, for example, like an individual input disease model.

The blended prediction can be the mean expectation value the physiological parameter of interest, for example, blood glucose level for glucose modeling. Such blending represents a “super model” derived from individual models and historical experimental observations. As noted above, even under “ideally” the same conditions, the responses of human or other biological systems will have a distribution. Thus, certain machine learning algorithms, exemplified by quantile forest and quantile regression are preferred because applying these machine learning algorithms used to train the blended model may generate a super model that predicts not only the mean expectation but also the probabilistic distribution of the prediction of physical parameter of interest. Such machine learning algorithms provide better decisions, as a narrower probabilistic distribution indicates a more reliable prediction and vice versa.

In the aforementioned description of the methodology, all available experimental observations for training the machine-learning algorithms are included for training the machine-learning algorithm and establishing the super-model. In biological systems, often there are outlier behaviors. The outlier behavior can occur for particular systems or occur within certain specific time periods of an otherwise normal system. The outlier behaviors may need to be identified so that they can be excluded from training data set and a predictive model for outlier behavior may be established. In an exemplary implementation, outliers may be identified by the super-model approach using cross-validation in an iterative fashion as discussed below.

In the first round of super-model training, one uses a fraction of the available historical data set. For example, this can be data from 95% of the patients or 95% of the data from every patient. This fraction of data is used to establish a super-model that predicts the probabilistic distribution of the physiological parameter of interest using the method captured in FIG. 1. The super-model is then used to predict the rest of the 5% holdout, which is compared to the observation of the physiological parameter of interest. If an observation is highly unlikely (one may set of a threshold of, for example, less than 1%) according to the prediction, it may be labeled as an outlier. This process is then performed iteratively by choosing another set of 95% for training and 5% for hold-out data. Once all the outliers in a historical dataset are labeled, one may further correlate the outliers with critical parameters identified using a classification machine-learning algorithm so that outlier occurrence can be predicted.

FIG. 2 is a process flow of a method of predicting progression of diabetes or response to a diabetes treatment in a patient according to an embodiment. At block 210, selecting inputs that include a patient's current physiological condition and/or treatment plan are performed. At block 220, estimates of future blood glucose levels are determined using individual models. At block 230, experimental observations, including measured blood glucose levels from the patient are identified. At block 240, critical parameters are identified. At block 250, a blended model from the individual models, critical parameters, and experimental observations is obtained. At block 260, future blood glucose levels that mark progression of diabetes or response to treatment are predicted.

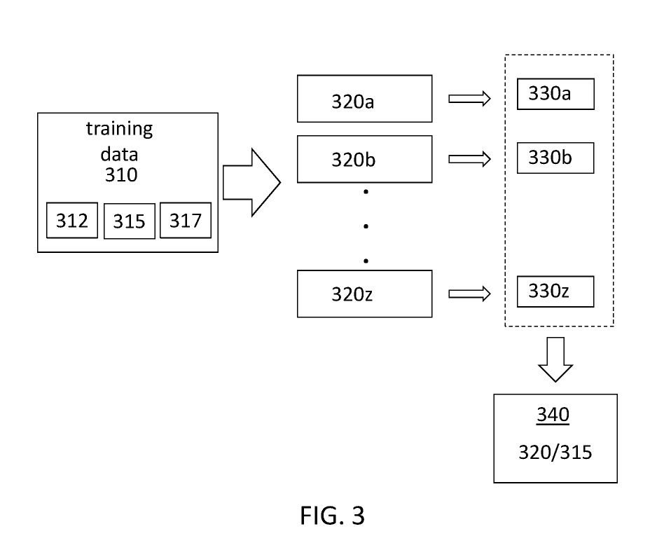

FIG. 3 is a process flow of a method of predicting progression of a disease or a response to a treatment in a patient according to an embodiment. The multi-expert based machine learning technique determines the most appropriate machine learning algorithm for a given situation (for a given subspace or range of values of the critical parameters). As detailed below, the multi-expert based machine learning determines the best machine learning algorithm with which to train a machine learning model for each situation.

Initially, all the candidate machine leaning algorithms are used to train the respective different machine learning models 320a through 320z using part of the available data 310 (estimates of all parameters (including the physiological parameter of interest 312 and critical parameters 315) and, additionally, experimental measurements of the parameter of interest 317). Only part of the available data 310 is used so that the remaining data 310 may be used to test the machine learning models 320. For example, if a year's worth of data 310 is available, only the first eleven months of data may be used to train the machine learning models 320.

Exemplary machine learning algorithms 320 include a linear regression, random forest regression, gradient boosting regression tree, support vector machine, and neural networks. The estimates or predictions 330a through 330z of the parameter of interest (at various points of time) by each machine learning model 320a through 320z, respectively, are obtained for the period of time for which historical data 310 is available but was not used for training (e.g., the remaining month of the year in the example noted above). At each point in time, the machine learning model and corresponding critical parameters 320/315 associated with the most accurate prediction 330 among all the predictions 330 is determined. The accuracy is determined based on a comparison of the estimates 330a through 330z with the historical data 310 available for the period during which the estimates 330a through 330z are obtained. The resulting set of (most accurate) machine learning model and critical parameters 320/315 combinations is stored as the combinations 340 and is used to obtain the situation-based blended model. That is, when the blended model is to be used, all critical parameters are estimated by all individual models. Based on the estimated ranges for the critical parameters 315, the corresponding machine learning model 320 from the stored combinations 340 is selected for use.

In alternate embodiments, the critical parameters 315 may be used to obtain the parameter-based blended model using another machine learning technique. That is, the combinations (340) of machine learning model and critical parameters 320/315 may be used to train a classification machine learning model to correlate the machine learning model 320 with critical parameters 315. Once the classification machine learning model is trained, inputting critical parameters 315 will result in obtaining the appropriate machine learning model 320 (blended model).

In yet another embodiment, a single machine learning model 320 may be selected from among the set of most accurate machine learning models 320. For example, the machine learning model 320 that is most often the most accurate machine learning model 320 (for more points in time) may be selected as the blended model. According to this embodiment, no correlation of machine learning model 320 to critical parameters 315 is needed.

The training data 310 discussed with reference to FIG. 3 may be measured directly from the patient. However, in some situations, training data specific to the patient may not be available. The lack of patient-specific training data may be addressed in a number of ways. According to an embodiment detailed below in FIG. 4, patients are analyzed for similarities and categorized such that proxy patients may be identified when particular patients of interest fail to have training data.

FIG. 4 is a process flow of a method of classifying patients in a pool and obtaining proxy patients according to an embodiment. At block 410, determining critical parameters for a pool of patients may include performing the processes discussed above. Grouping patients together that have the same critical parameters is performed at block 420. The patients within a given group must have all critical parameters in common rather than just a subset.

For each group of patients, a further classification is then performed at block 430 that involves classifying the patients by type. This classification may be based on the estimation error dependence (of the physiological parameter of interest) on the corresponding critical parameters of the group of patients, as detailed below. In alternate embodiments, static information on the patient, such as gender, may be used in addition to the estimation error dependence for patient classification (as additional coefficients). This classification at block 430 sorts the patients by type.

At block 440, correlating the type of patient with physiological variables may include training a supervised classification model that correlates patient type with a set of static physiological variables, for example, gender, height, weight, age, years with a given disease, etc. Exemplary algorithms for training the supervised classification model include the random forest algorithm, regression tree, support vector machine, and neural networks. The training data used to train the classification model consists of patient type as determined at block 430 (response variable) and with corresponding static physiological variables (predictor variables).

Once the classification model is trained at block 450, determining a patient type for any patient is a matter of entering the physiological variables of that patient to the classification model for output of the patient type. By using the patient type, proxy patients (patients of the same type) may be identified from the original set of patients for which measurements were available (at block 410). As noted above with reference to FIG. 1, block 150, training data may be obtained from a proxy patient when the patient of interest has no historical or measured data available. One or more proxy patients may be used to provide the training data.

The classification at block 430 may begin with the first and second order error (in the estimate of the physiological parameter of interest) dependence determined using FANOVA as discussed with reference to embodiments above. Polynomial models are fit to the first and second order error dependence for each patient. For example, a linear model is fit to the first order error estimate and a quadratic model is fit to the second order error estimate. Thus, a first order error dependence curve is translated into two polynomial coefficients (the slope and intercept of the line fit to the graph) and a second order error dependence surface is translated to six coefficients. Accordingly, an individual patient is associated with a set of polynomial coefficients corresponding to all of its first and second order error dependences of the parameter of interest. Using an unsupervised clustering machine learning algorithm (e.g., method of moments, k-means clustering, Gaussian mixture model, neural network), each patient may be classified according to its set of coefficients. An input to the clustering machine learning algorithm is the number of total types of patients into which to sort the available patients. Given this number, the clustering algorithm may compute and use a measure of similarity among sets of coefficients (each set associated with a different patient) to sort the patients.

In an alternative embodiment, the classification at block 430 and, specifically, the generation of the coefficients may be done differently. For each patient, a linear model of the parameter of interest (y) may be fit to all or a subset of the critical parameters (x₁ through xₙ) associated with the patient. The coefficients (a₁ through aₙ) may then be determined from the linear model (y=a₁x₁+a₂x₂+ . . . +aₙxₙ). This set of coefficients (a₁ . . . aₙ) rather than the coefficients obtained from the first order error dependence curve and second order error dependence surface, as discussed above, may be used with the clustering machine learning algorithm to sort the patients into patient types.

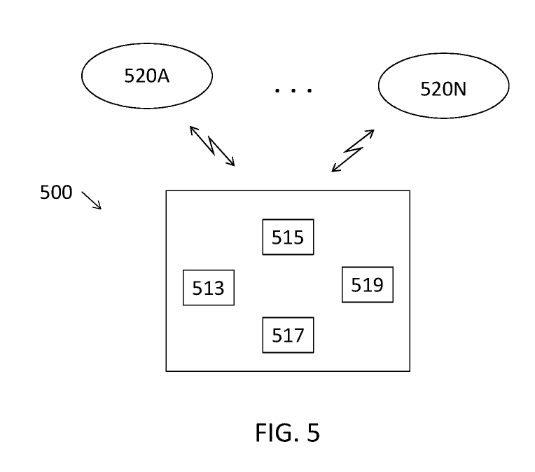

FIG. 5 is a block diagram of a multi-model blending system 500 for predicting progression of a disease or a response to a treatment in a patient according to an embodiment. The system 500 includes an input interface 513, one or more processors 515, one or more memory devices 517, and an output interface 519. The system 500 may communicate, wirelessly, through the internet, or within a network, for example, with one or more devices 520A through 520N (generally, 520). The other devices 520 may be other systems 500 or sources of training data or model outputs. That is, not all of the models may be executed within the multi-model blending system 500. Instead, one or more individual models may be implemented by another device 520 and the output (predicted or estimated parameters) provided to the input interface 513. The processes detailed above (including identifying critical parameters and classifying patient types) may be executed by the system 500 alone or in combination with other systems and devices 520. For example, the input interface 513 may receive information about the physiological parameter of interest and the patient of interest (and the number of patient types), as well as receive training data or model outputs. The processor may determine the critical parameters for a set of models providing a given parameter of interest, as detailed above.

All of the embodiments discussed herein ultimately improve the area of medicine in which a patient's physiological parameter of interest is predicted to determine disease progression or response to particular treatment. For example, when the individual models used, as described above, relate to disease prediction, the embodiments detailed herein improve the disease prediction, and, thus, reliability in the disease treatments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of predicting progression of a disease in a patient, the method comprising:
obtaining, via a processor, set of individual predictive disease models, wherein each individual predictive disease model in the set includes a plurality of inputs that correlate a disease with a plurality of weighted physiological parameters;
generating, via the processor, for each individual predictive disease model in the set, physiological parameters of interest for each individual predictive disease model by:
varying, via the processor, each of the plurality of inputs correlating the disease with the weighted physiological parameters by creating a sub-range of each critical parameter per iteration;
comparing, via the processor, the sub-range for each of the plurality of inputs with a database of experimental patient observations correlating physiological parameters with input values; and
generating, via the processor, the estimate of the physiological parameters of interest based on the comparison of the varied plurality of inputs and a predicted error estimation;
identifying, via the processor, for each model of the set of individual predictive disease models, parameters that have a greatest influence on an error in estimation of the physiological parameters of interest, the identifying comprising:
identifying, via the processor, a plurality of critical parameters based on a predetermined influence weight by evaluating a first order error dependence, a second order error dependence, and an inter-model second order error dependence;
correlating, via the processor, the plurality of critical parameters with the sub-range for each of the plurality of inputs; and
generating, via the processor, a blended model for each of the sub-ranges for each of the plurality of inputs the correlation; and
predicting, via the processor, a disease progression based on the blended models.

2. The method according to claim 1, wherein the range of inputs include a physiological condition of the patient and treatment plan.

3. The method according to claim 2, wherein the treatment plan is that no treatment is applied.

4. The method according to claim 1, wherein determining the prediction includes determining a mean value or a probabilistic distribution of a physiological quantity of interest.

5. The method according to claim 1, wherein the disease is diabetes, and the physiological parameter of interest is blood glucose level.

6. The method according to claim 1, wherein obtaining, for each subspace of all possible combinations of critical parameters, a blended model includes obtaining a training data set within the subspace for use with a machine learning algorithm.

7. The method according to claim 6, wherein proxy patients that provide training data are determined when training data is not available for the patient.

8. (canceled)

9. A system to predict progression of a disease in a patient, the system comprising:
an input interface configured to obtain a set of individual predictive disease models, wherein each individual predictive disease model in the set includes a plurality of inputs that correlate a disease with a plurality of weighted physiological parameters; and
a processor configured to:
generate, for each individual predictive disease model in the set, physiological parameters of interest for each individual predictive disease model,
vary each of the plurality of inputs correlating the disease with the weighted physiological parameters by creating a sub-range of each critical parameter per iteration;
compare the sub-range for each of the plurality of inputs with a database of experimental patient observations correlating physiological parameters with input values; and
generate the estimate of the physiological parameters of interest based on the comparison of the varied plurality of inputs and a predicted error estimation;
identify, for each model of the set of individual predictive disease models, parameters that have a greatest influence on an error in estimation of the physiological parameters of interest;
identify a plurality of critical parameters based on a predetermined influence weight by evaluating a first order error dependence, a second order error dependence, and an inter-model second order error dependence;
correlate the plurality of critical parameters with the sub-range for each of the plurality of inputs; and
generate a blended model based on the correlation; and
predict a disease progression based on the blended models.

10. The system according to claim 9, wherein the processor identifies the critical parameters based on examining first order dependence of the error in the estimation of the physiological parameter of interest associated with each of the parameters estimated by each of the set of individual models.

11. The system according to claim 10, wherein the processor identifies the critical parameters based on calculating a variance from the first order dependence associated with each of the physiological parameters estimated by each individual predictive disease model.

12. The system according to claim 11, wherein the processor identifies the critical parameters based on identifying parameters among the physiological parameters estimated by the individual predictive disease models with an associated variance exceeding a threshold value.

13. The system according to claim 10, wherein the processor identifies the critical parameters based additionally on examining second or higher order dependence of the error in the estimation of the physiological parameter of interest associated with combinations of parameters estimated by each individual predictive disease model.

14. The system according to claim 10, wherein the processor identifies the critical parameters based additionally on examining inter-model second order dependence of the error in the estimation of the physiological parameter of interest associated, the inter-model second order dependence of the error referring to how error in estimation of the physiological parameter of interest is correlated to a first parameter estimated by a first model and a second parameter estimated by a second model among the set of individual predictive disease models.

15. The system according to claim 9, wherein the processor obtains, for each subspace of all possible combinations of critical parameters, a blended model by performing multi-expert based machine learning involving training a plurality of machine learning models with respective machine learning algorithms and determining a most accurate machine learning model for each subspace of critical parameters.

16. A non-transitory computer program product having computer readable instructions stored thereon which, when executed by a processor, cause the processor to implement a method of predicting progression of a disease in a patient, the method comprising:
obtaining, via the processor, a set of individual predictive disease models, wherein each individual predictive disease model in the set includes a plurality of inputs that correlate a disease with a plurality of weighted physiological parameters;
generating, via the processor, for each individual predictive disease model in the set, physiological parameters of interest for each individual predictive disease model by:
varying, via the processor, each of the plurality of inputs correlating the disease with the weighted physiological parameters by creating a sub-range of each critical parameter per iteration;
comparing, via the processor, the sub-range for each of the plurality of inputs with a database of experimental patient observations correlating physiological parameters with input values; and
generating, via the processor, the estimate of the physiological parameters of interest based on the comparison of the varied plurality of inputs and a predicted error estimation;
identifying, via the processor, for each model of the set of individual predictive disease models, parameters that have a greatest influence on an error in estimation of the physiological parameters of interest, the identifying comprising:
identifying, via the processor, a plurality of parameters based on a predetermined influence weight by evaluating a first order error dependence, a second order error dependence, and inter-model second order error dependence;
correlating, via the processor, the plurality of critical parameters with the sub-range for each of the plurality of inputs; and
generating, via the processor, a blended model for each of the sub-ranges for each of the plurality of inputs based on the correlation; and
predicting, via the processor, a disease progression based on the blended model.

17. The non-transitory computer program product according to claim 16, wherein the disease is diabetes, and identifying experimental observations includes identifying measured blood glucose levels.

18. (canceled)

19. The non-transitory computer program product according to claim 16, wherein determining the prediction includes determining a mean value or a probabilistic distribution of a physiological quantity of interest.

20. The non-transitory computer program product according to claim 16, determining a prediction of the physiological parameter of interest is performed for the patient without experimental observations from the patient.
